(19) United States
(12) Patent Application Publication
(10) Pub. No.: US 2023/0154363 A1
(43) Pub. Date: May 18, 2023

(54) SAFETY FLAG DEVICE

(71) Applicant: David Darrin TUTTLE, Stony Plain (CA)

(72) Inventor: David Darrin TUTTLE, Stony Plain (CA)

(21) Appl. No.: 17/528,885

(22) Filed: Nov. 17, 2021

(51) Int. Cl. G09F 17/00

(52) U.S. Cl. CPC G09F 17/00; G09F 2017/0075; G09F 2017/0025; G09F 2017/0083

(57) ABSTRACT

A safety flag device is provided. In one embodiment, the safety flag device comprises a housing comprising: one or more reversible attachment means for reversibly attaching said housing to an exterior surface of a vehicle; a first switch; and a reversibly extendable pole, the base thereof being coupled to said housing; a rod secured at the tip of the reversibly extendable pole, along a same axis thereof; a flag reversibly attached to the rod; and the housing further comprising therein: a container for housing a portion of a long flexible cable, the long flexible cable passing through the interior of the reversibly extendable pole and being attached to the tip thereof; an electrical motor mechanically coupled to the long flexible cable and operable to, via said first switch, move the long flexible cable up or down so as to extend or retract the reversibly extendable pole.

### FIELD OF THE INVENTION

The present disclosure relates to a safety flag, more specifically, but not by way of limitation, more particularly to a safety flag device that is reversibly extendable, motorized, reversibly attachable to any vehicle and controlled remotely.

### BACKGROUND

Any discussion of the related art throughout the specification should in no way be considered as an admission that such related art is widely known or forms part of common general knowledge in the field.

Safety whips are often used to increase the visibility of vehicles. They usually comprise an eye catching flag mounted atop a pole or mast that is attached to a vehicle to increase the visibility thereof. However, currently most safety flags disclosed in the prior art have to be assembled and dissembled for use and storage, respectively. In addition, height restrictions in some areas prevent the use of safety whips permanently affixed to the vehicle. Similarly, it is often not possible to drive on public roads with an extended safety whip. Finally, some vehicle types cannot or are not configured to have a safety whip attached thereto.

It has previously been recognized that there exists a need for a safety flag apparatus or device that is reversibly extendable, motorized, and configured to be controlled remotely.

AU Pub. No. 2020/227031 A1 (Vegh) discloses a safety flag deployment apparatus for a vehicle. Shortcomings include a lack of a LED light.

CA Pub. No. 2771680 A1 (McMeekin et al.) discloses a vehicle emergency safety light. Shortcomings include an inability to be controlled remotely.

CN Pub. No. 108109557 A (Li et al.) discloses a vehicle-mounted flag folding device. Shortcomings include an inability to telescopically retract or extend the safety flag and an inability to be controlled remotely.

U.S. Pub. No. 2007/0283875 A1 (Durkin) discloses an emergency signaling system. Shortcomings include a lack of LED lights, and of an inability to be controlled remotely.

U.S. Pat. No. 6,046,706 A (Vargas) discloses an antenna mast and method using same. Shortcomings include a lack of removable flag and an inability to be controlled remotely.

U.S. Pat. No. 6,057,787 A (Kell et al.) discloses an automatic safety flag for boats and water recreational vehicles. Shortcomings include a lack of an inability to be controlled remotely.

U.S. Pat. No. 7,367,700 B2 (Chasmar) discloses a safety whip mast. Shortcomings include a lack of motorization and an inability to be controlled remotely.

U.S. Pat. No. 8,302,552 B2 (Dover) discloses a retractable caution flag for mounting on a vehicle. Shortcomings include an inability to be controlled remotely.

U.S. Pat. No. 9,928,764 B2 (Heath et al.) discloses an illuminated support mount for a vehicle flag. Shortcomings include an inability to retract or extend the flag and a lack of motorization.

U.S. Pat. No. 10,995,916 B1 (Murphy) discloses a rigid and lighted flag for a vehicle. Shortcomings include an inability to retract/extend the flag and a lack of motorization.

All documents cited herein are incorporated by reference.

It is clear that there exists a need for a safety whip device or apparatus that is reversibly extendable, motorized, reversibly attachable to any vehicle and that can be controlled remotely.

### BRIEF SUMMARY

It is an object of the invention to provide a safety flag device that is reversibly extendable, motorized, reversibly attachable to any vehicle and that can be controlled remotely.

In accordance with one aspect, there is presented a safety flag device comprising: a housing, the housing comprising: one or more reversible attachment means for reversibly attaching said housing to an exterior surface of a vehicle; a first switch; and a reversibly extendable pole, the pole having a base coupled to said housing and a tip; a rod secured to the tip of the reversibly extendable pole, along a same axis thereof; a flag reversibly attached to the rod; and the housing further comprising therein: a container for storing a portion of a long flexible cable, the long flexible cable passing through an interior volume of the reversibly extendable pole and being attached to the tip thereof; an electrical motor mechanically coupled to the long flexible cable, and electrically coupled to the first switch and an electrical power source, and operable to, via said first switch, move the long flexible cable up or down inside the reversibly extendable pole so as to extend or retract the reversibly extendable pole.

In one embodiment, the reversibly extendable pole is a telescopic pole comprising a plurality of concentric cylindrical tube elements that are slidingly coupled.

In one embodiment, the electrical motor is operable to partially extend or partially retract the reversibly extendable pole.

In one embodiment, the housing further comprises one or more handles thereon.

In one embodiment, the rod is screwingly secured to the tip of the reversibly extendable pole.

In one embodiment, the safety flag device further comprises: a second switch electrically coupled to said power source; at least one lighting element affixed at an upper tip of the rod electrically coupled to said second switch; wherein the at least one lighting element is configured to be turned on or off via said second switch.

In one embodiment, the at least one lighting element is a light-emitting diode (LED).

In one embodiment, the electrical power source is an external electrical power source located outside of said housing and wherein the housing further comprises: a set of power studs electrically coupled to said first switch and said electrical motor for electrically coupling said first switch and said electrical motor to the external electrical power source.

In one embodiment, the external electrical power source is a battery of the vehicle.

In one embodiment, the electrical power source is an internal electrical power source located inside of said housing.

In one embodiment, the internal electrical power source is a lithium-ion battery.

In one embodiment, the one or more reversible attachment means comprise one or more magnets to magnetically couple the housing to the exterior surface of the vehicle.

In one embodiment, the reversible attachment means comprise one or more brackets configured to slidingly engage one or more mounting rails affixed to the exterior surface of the vehicle.

In one embodiment, the safety flag further comprises in said housing: a wireless control module electrically coupled to said first switch and said second switch and configured to allow the remotely control the at least one lighting element and the electric motor.

In one embodiment, the wireless control module is a Wi-fi control module remotely controlled via a mobile device or remote control.

In one embodiment, the wireless control module is a Bluetooth® control module electrically coupled to said first switch via a 2-relay module.

In accordance with another embodiment, there is presented a kit for installing a safety flag device to a vehicle, the kit comprising: one or more mounting rails; one or more fastening means; the safety flag device comprising: a housing, the housing comprising: one or more brackets; a first switch; and a reversibly extendable pole, the pole having a base coupled to said housing and a tip; a rod secured to the tip of the reversibly extendable pole, along a same axis thereof; a flag reversibly attached to the rod; and the housing further comprising therein: a container for storing a portion of a long flexible cable, the long flexible cable passing through an interior volume of the reversibly extendable pole and being attached to the tip thereof; an electrical motor mechanically coupled to the long flexible cable, and electrically coupled to the first switch and an electrical power source, and operable to, via said first switch, move the long flexible cable up or down inside the reversibly extendable pole so as to extend or retract the reversibly extendable pole.

In one embodiment, the kit further comprises instructions for installing the safety flag device, the instructions comprising the steps of: fastening the one or more mounting rails to an exterior surface of the vehicle via the one or more fastening means; and slidingly engaging via the one or more brackets of the safety flag device the one or more mounting rails, thereby installing the safety flag device on the vehicle.

In one embodiment, the fastening means comprise: a plurality of bolts and nuts; a plurality of spacers; and a plurality of washers.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIGS. 1A and 1B illustrate perspective views of a safety flag device, according to some embodiments.

FIGS. 2A, 2B and 2C illustrate perspective views of a safety flag device having the reversibly extendable pole retracted (FIG. 2A), partially extended (FIG. 2B) or fully extended (FIG. 2C), according to some embodiments.

FIGS. 3A and 3B illustrate perspective views of the interior of the housing of the safety flag device, in accordance with one embodiment.

FIGS. 4A and 4B illustrate a perspective view (FIG. 4A) of a housing comprising thereon magnets, and a rear view (FIG. 4B) of a vehicle having the safety flag device removably attached thereto via said magnets, in accordance with one embodiment.

FIGS. 5A and 5B illustrate a perspective view (FIG. 5A) of a housing comprising brackets thereon, and a rear view (FIG. 5B) of a vehicle having the safety flag removably installed thereon by slidingly engaging the brackets on rails installed on the vehicle, in accordance with one embodiment.

FIG. 6 illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The disclosure proposes a safety flag device that is reversibly extendable, motorized, reversibly attachable to any vehicle and that can be controlled remotely that overcomes disadvantages inherent in the existing safety flag devices, such as, but not limited to, an inability to retract or extend the flag, a lack of motorization, an inability to reversibly attach the device to any vehicle, and an inability to be controlled remotely. The present invention provides a safety flag device that may be used with many different forms. As such, the general purpose of the present invention, which will be described subsequently in greater detail, is to provide a new and improved safety flag device, which provides the advantages and overcomes the aforementioned disadvantages.

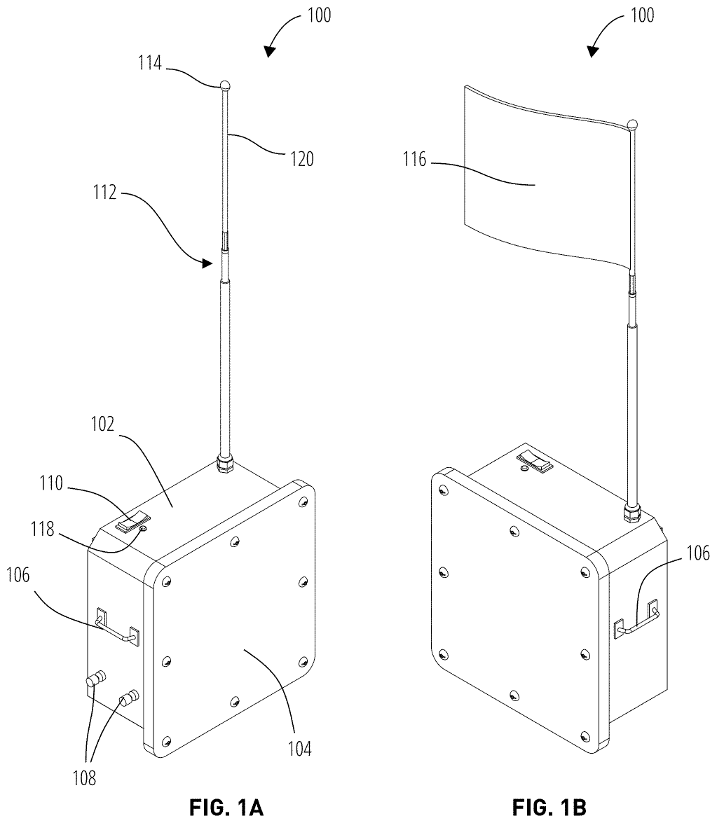

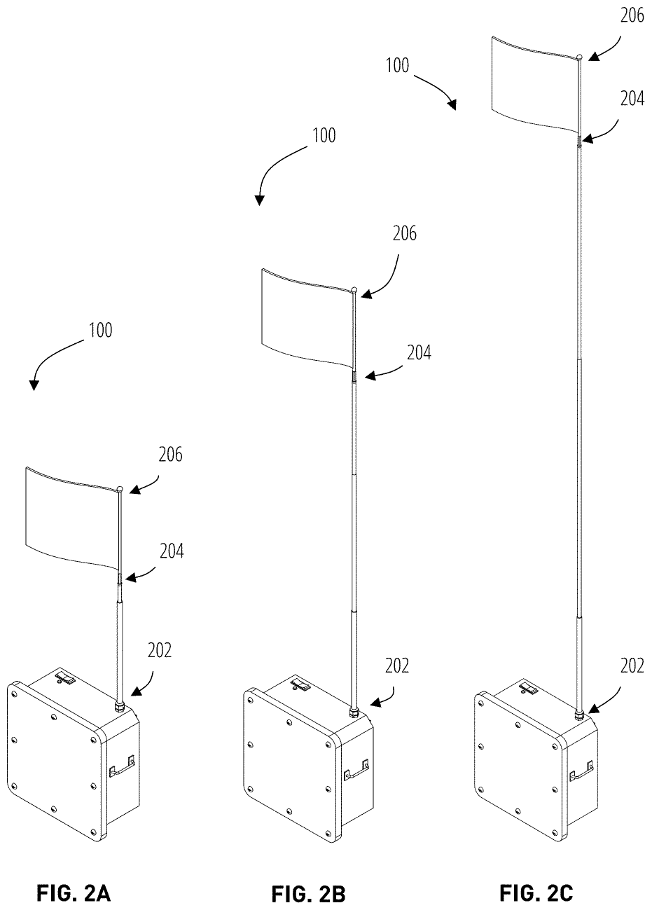

FIGS. 1A and 1B illustrate a safety flag device 100, according to some embodiments. The safety flag device 100 of FIGS. 1A and 2B comprises a housing 102 which may be removably attached to a vehicle. In this example, the housing 102 is shown comprising an access panel 104 , a switch 110, and a toggle switch 118 thereon. The housing 102 typically houses the motorizing means of the safety flag device 100, and/or any other additional components. In some embodiments, the housing 102 may be made of PVC or a similar impact resistant material. The access panel 104 is removably coupled to the housing 102, for example using screws or the like, for accessing the interior of the housing 102. In some embodiments, the housing 102 may have a size of approximately 13″×13″×7″.

A reversibly extendable pole 112 is coupled at the proximal end to the top of the housing 102. In some embodiments, the pole 112 is a telescopic pole comprising a plurality of concentric cylindrical tube elements that are slidingly coupled and configured to be slidingly moved between a retracted configuration and an extended configuration. In some embodiments, the pole 112 may be extended or retracted via the switch 110. In some embodiments, the switch 110 may be a spring loaded switch, such as a 3 way 6 prong spring loaded switch or similar.

In some embodiments, removably attached to the distal end or tip of pole 112 along a same axis thereof is a rod 120 which is used to removably attach a warning flag 116 thereto, as seen in FIG. 1B. In some embodiments, the rod 120 may be screwingly secured to the pole 112, although the skilled person in the art will appreciate that other non-permanent attachment means may also be used know in the art.

In some embodiments, flag 116 may be any kind of flag used in the art. This may include flexible flags and/or rigid flags. The skilled person in the art will appreciate that different materials may be used, including, but not limited to: plastic, fabric, and/or metal materials. In some embodiments, the flag 116 may be removably attached to the rod 120 via one or more fastening means, including, for example, Velcro straps or the like. This allows the flag 116 to be interchanged as needed, for example if another type of flag is required and/or if the current flag is damaged and needs to be replaced. In other embodiments, the flag may be permanently affixed to the rod 120 and attached/removed from the safety flag device 100 by attaching/detaching the rod 120 from the distal end of the pole 112.

In some embodiments, a lighting element 114 may be coupled or attached to the distal end of the rod 120. Different types of lighting elements may be used, for example light emitting device (LED) lights or the like. In some embodiments, one or more additional lighting elements may also be coupled or attached to the housing 102 and/or rod 120. Flexible wiring cables (not shown) are installed inside both the pole 112 and the rod 120 so as to electrically couple the lighting element 114 to a power source (either inside the housing 102 or outside of it) and the toggle switch 118. For example, in some embodiments, a 2-wire 22-gauge AWG coated wire may be used. In some embodiments, a single switch may be used for both switch 110 and toggle switch 118, so to both extend the pole 112 and turn on the lighting element 114 simultaneously.

In some embodiments, the housing 102 further comprises, for ease of transportation purposes, one or more handles 106 thereon. The skilled person in the art will appreciate that a different number of handles may be used than the two handles 106 of FIGS. 1A and 1B, and/or that the handles 106 may be placed differently on the surface of the housing 102.

In some embodiments, as shown in FIGS. 1A and 1B, the housing 102 may further comprise power studs 108 for electrically coupling the housing 102 to an external electrical power source (not shown). This may include the vehicle's 12V battery, or another external 12V battery. In some embodiments, the voltage of the external battery may differ from 12V, and a power adapter (not shown) may be used to change the voltage to a desired value.

FIGS. 2A, 2B and 2C show the safety flag device 100 of FIGS. 1A and 1B in three different configurations: one where the pole 112 is completely retracted (FIG. 2A), one where the pole 112 is partially extended (FIG. 2B) and one where the pole 112 is completely or fully extended (FIG. 2C). For example, in one embodiment, the pole 112 may be comprised of a 7-piece telescopic carbon fiber element, having at its base 202 a diameter of 27 mm and having a length from the base 202 to the tip 204 of 42 cm in the retracted configuration (FIG. 2A), and a total length of 245 cm in the fully extended configuration (FIG. 2C). The length of the rod 120 (from the tip 204 of the extendable pole 112 to the upper end 206 of the rod 120) may be selected, for example depending on the size of the flag 116 that is to be attached thereto. In one example, the rod 120 has a diameter of 10 mm and a length of 13 inches.

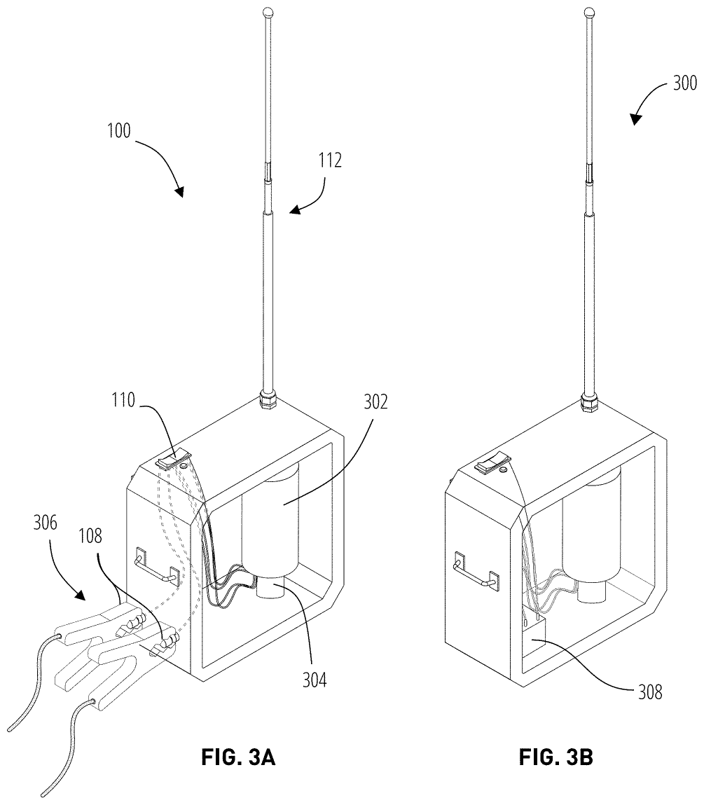

FIG. 3A shows the safety flag device 100 with the access panel removed. An electrical motor 302 is used to actuate or operate the reversibly extendable pole 112. In some embodiments, the electrical motor 302 is a directional 12V bi-directional brushed motor with a 38.4 mm diameter helical gear with 33 teeth. The electrical motor 302 is used to moved or actuate a long thin flexible cable (not shown) stored inside the flexible cable container 304. The long flexible cable is affixed at one end to the distal end of the extendable pole 112. By pushing or pulling the flexible cable up or down with the electrical motor 302, the extendible pole 112 is extended or retracted. In some embodiments, the flexible cable may have a diameter of 8 mm and a length of 3 meters. In some embodiments, the flexible cable container 304 may be a hollow rounded plastic container or canister. In some embodiments, the container 304 may further comprise a reel or the like for the long flexible cable to be rolled thereon or unrolled therefrom.

FIG. 3A further shows the electrical motor 302 being electrically coupled to the switch 110, toggle switch 118 and the power studs 108. As an example, the power studs 108 are shown being connected to an external battery (not shown), for example the vehicle's 12V battery, via a set of alligator clips 306.

FIG. 3B shows a safety flag device 300, which comprises all of the elements of the safety flag device 100 discussed above, but which comprises an internal power source 308 therein instead of relying on an external power source. The internal power source 308 is shown being electrically coupled to the switch 110, toggle switch 118 and the electrical motor 302. In some embodiments, the internal power source 308 may be a 12V lithium ion battery or the like.

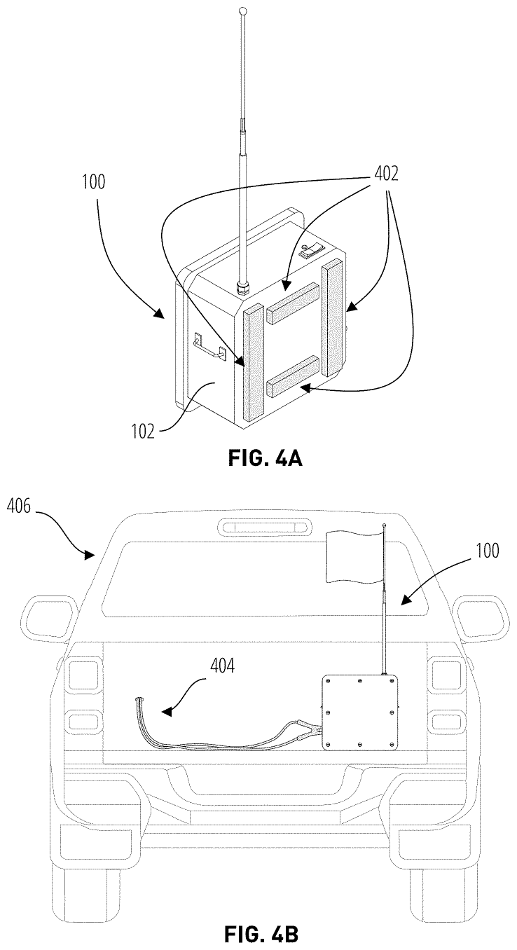

FIGS. 4A and 4B show two different examples of affixing means used to removably attach the safety flag device 100 (for example) to a vehicle. FIG. 1A shows the back side of the housing 102 comprising a plurality of magnets 402 affixed thereto. As shown in FIG. 4B, the magnets 402 are used to magnetically couple the housing 102 to the frame of a vehicle 406. In some embodiments, these may be neodymium magnets to provide a strong magnetic coupling with the metallic frame of the vehicle.

In the example of FIG. 4B, the housing 102 is magnetically coupled to the frame of a pickup truck, against the back wall of the driver's cabin. An aperture 404 in the truck's cabin is shown being used to pass therethrough electrical wires to connect the safety flag device 100 to the truck's battery.

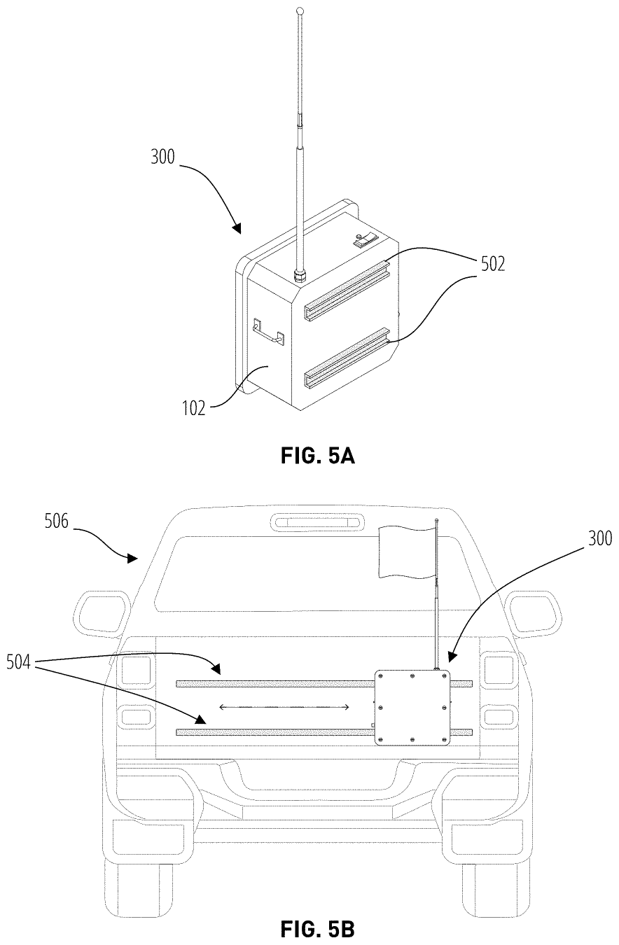

FIGS. 5A and 5B show, in accordance with another embodiment, another means of removably attaching the safety flag device 300 (for example) to a vehicle. As illustrated in FIG. 5A, the backside of the housing 102 is shown having affixed thereon a set of brackets 502. The brackets 502 may be used to slidingly engage with mounting rails 504 affixed on a vehicle 506.

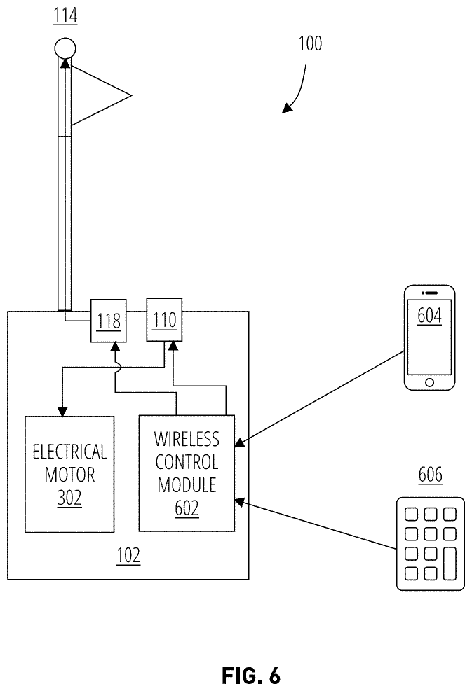

FIG. 6 shows a schematic diagram illustrating, in accordance with some embodiments, the safety flag device 100 (or 300) may further comprising a wireless control module 602 communicatively connected or coupled to the switch 110 and/or the toggle switch 118 for remotely extending and/or retracting the extendable pole 112, and /or turning the lighting element 114 on or off, respectively. The wireless control module 602 can be controlled either a mobile device 604 like a smartphone or the like, and/or with a remote control 606. This allows the safety flag device 100 (300) to be configured or deployed remotely, for example from inside the vehicle. In some embodiments, the mobile device 604 may be configured to control the safety flag device 100 (or 300) via an software application or the like that is installed thereon.

In some embodiments, the wireless control module may be, for example, a Bluetooth® control module or a Wi-fi control module. It can be connected to the switch 110 or toggle switch 118 via one or more relay modules or the like. The skilled person in the art will appreciate that other wireless technologies for remotely controlling a device via a mobile device or remote control may also be used, without restriction.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A safety flag device, comprising:
a housing, the housing comprising:
one or more reversible attachment means for reversibly attaching said housing to an exterior surface of a vehicle;
a first switch; and
a reversibly extendable pole, the pole having a base coupled to said housing and a tip;
a rod secured to the tip of the reversibly extendable pole, along a same axis thereof;
a flag reversibly attached to the rod; and
the housing further comprising therein:
a container for storing a portion of a long flexible cable, the long flexible cable passing through an interior volume of the reversibly extendable pole and being attached to the tip thereof;
an electrical motor mechanically coupled to the long flexible cable, and electrically coupled to the first switch and an electrical power source, and operable to, via said first switch, move the long flexible cable up or down inside the reversibly extendable pole so as to extend or retract the reversibly extendable pole.

2. The safety flag device of claim 1, wherein said reversibly extendable pole is a telescopic pole comprising a plurality of concentric cylindrical tube elements that are slidingly coupled.

3. The safety flag device of claim 1, wherein said electrical motor is operable to partially extend or partially retract the reversibly extendable pole.

4. The safety flag device of claim 1, the housing further comprises one or more handles thereon.

5. The safety flag device of claim 1, wherein the rod is screwingly secured to the tip of the reversibly extendable pole.

6. The safety flag device of claim 1, further comprising:
a second switch electrically coupled to said power source;
at least one lighting element affixed at an upper tip of the rod electrically coupled to said second switch;
wherein the at least one lighting element is configured to be turned on or off via said second switch.

7. The safety flag device of claim 6, wherein said at least one lighting element is a light-emitting diode (LED).

8. The safety flag device of claim 1, wherein said electrical power source is an external electrical power source located outside of said housing and wherein the housing further comprises:
a set of power studs electrically coupled to said first switch and said electrical motor for electrically coupling said first switch and said electrical motor to the external electrical power source.

9. The safety flag device of claim 8, wherein said external electrical power source is a battery of the vehicle.

10. The safety flag device of claim 1, wherein said electrical power source is an internal electrical power source located inside of said housing.

11. The safety flag device of claim 10, wherein said internal electrical power source is a lithium-ion battery.

12. The safety flag device of claim 1, wherein said one or more reversible attachment means comprise one or more magnets to magnetically couple the housing to the exterior surface of the vehicle.

13. The safety flag device of claim 1, wherein said reversible attachment means comprise one or more brackets configured to slidingly engage one or more mounting rails affixed to the exterior surface of the vehicle.

14. The safety flag device of claim 6, further comprising in said housing:
a wireless control module electrically coupled to said first switch and said second switch and configured to allow the remotely control the lighting element and the electric motor.

15. The safety flag device of claim 14, wherein said wireless control module is a Wi-fi control module remotely controlled via a mobile device or remote control.

16. The safety flag device of claim 14, wherein said wireless control module is a Bluetooth® control module electrically coupled to said first switch via a 2-relay module.

17. A kit for installing a safety flag device to a vehicle, the kit comprising:
one or more mounting rails;
one or more fastening means;
the safety flag device comprising:
a housing, the housing comprising:
one or more brackets;
a first switch; and
a reversibly extendable pole, the pole having a base coupled to said housing and a tip;
a rod secured to the tip of the reversibly extendable pole, along a same axis thereof;
a flag reversibly attached to the rod; and
the housing further comprising therein:
a container for storing a portion of a long flexible cable, the long flexible cable passing through an interior volume of the reversibly extendable pole and being attached to the tip thereof;
an electrical motor mechanically coupled to the long flexible cable, and electrically coupled to the first switch and an electrical power source, and operable to, via said first switch, move the long flexible cable up or down inside the reversibly extendable pole so as to extend or retract the reversibly extendable pole.

18. The kit of claim 17, wherein said kit further comprises instructions for installing the safety flag device, the instructions comprising the steps of:
fastening the one or more mounting rails to an exterior surface of the vehicle via the one or more fastening means; and
slidingly engaging via the one or more brackets of the safety flag device the one or more mounting rails, thereby installing the safety flag device on the vehicle.

19. The kit of claim 17, wherein said fastening means comprise:
a plurality of bolts and nuts;
a plurality of spacers; and
a plurality of washers.
